(19) United States
(12) Patent Application Publication
(10) Pub. No.: US 2008/0026241 A1
(43) Pub. Date: Jan. 31, 2008

(54) STEEL TUBING WITH ENHANCED SLOT-ABILITY CHARACTERISTICS FOR WARM TEMPERATURE SERVICE IN CASING LINER APPLICATIONS AND METHOD OF MANUFACTURING THE SAME

(75) Inventors: Lucas Julian Pigliacampo, Campana (AR); Teresa Estela Perez, Campana (AR); Guillermo Patricio Echaniz, Campana (AR)

Correspondence Address: FITZPATRICK CELLA HARPER & SCINTO, 30 ROCKEFELLER PLAZA, NEW YORK, NY, 10112, US

(73) Assignee: ALGOMA TUBES, INC., Sault Ste. Marie (CA)

(21) Appl. No.: 11/780,568

(22) Filed: Jul. 20, 2007

Related U.S. Application Data
(60) Provisional application No. 60/832,950, filed on Jul. 25, 2006.

(51) Int. Cl. F16L 9/02; C21D 9/08; C22C 38/04

(52) U.S. Cl. 428/544; 148/328; 148/593

(57) ABSTRACT

A post-yield hardened steel tube, particularly useful for creating slotted liners, for use in various applications in the oil and gas industries. The steel specifications meet the broad API 5CT standard, but the resulting slotted tube exhibits both enhanced slot-ability characteristics and superior thermo-mechanical characteristics in buckling resistance and localization resistance. A method of manufacturing a steel tube with substantial post-yield hardening behavior across a temperature range between room temperature and 350° C. while providing good slot-ability, comprising using a steel meeting the broad API 5CT standard but with very small quantities of sulfur, performing a standard hot rolling process followed by a specifically defined heat treatment cycle, so as to create a microstructure characterized either ferrite plus pearlite or a ferrite plus bainite-pearlite.

### RELATED APPLICATION

This application claims the benefit of U.S. Provisional Patent Application No. 60/832,950 filed Jul. 25, 2006.

### BACKGROUND OF THE INVENTION

1. Field of The Invention

The present invention relates to controlling the mechanical properties of buckling resistance (or buckling “stability”) and localization resistance, while also improving a characteristic called “slot-ability”, that permits faster and less expensive slotting of steel tube, and particularly casing liners, using cutting blades. The present invention therefore relates to both a steel tube with enhanced slot-ability characteristics that will hold up to high temperature/high stress service in casing and tubing applications as well as a method of manufacturing such a steel tube.

As used herein “slot-ability” should be understood as a very specific subset of machinability, and is referred to the level of difficulty required to plunge a thin saw blade, with an approximate thickness the range of 0.010″ and 0.028″, through the side wall of a steel tubular. Slot-ability can be quantified as to how many times, or how well, a given saw blade may cut a slot in the tubular wall material before breaking. The importance of not confusing machinability with slot-ability can be appreciated from the general observation that K-55 materials are generally more “machinable” but at the same time less “slottable” than L-80 materials.

The steel tubing is particularly suited for use in the oil and gas industries for applications in which slotted liners are needed. Examples of such applications include sand control, horizontal wells and heavy oil recovery through steam injection, to name a few. The term SAGD service is used to reference steam-assisted gravity drainage, which is a particularly high temperature and high stress oilfield tubular procedure used for thermal oil recovery, and which particularly benefits from use of slotted liners as taught herein.

2. Brief Description of Prior Art

Slotted tubes are obtained by cutting longitudinal slots through the wall of a steel tube using very thin saw blades and machines specially designed for slotting steel. Once slotted, the tubes, in many applications, are installed in wells where they will serve in warm temperature environments. In one typical example, a slotted tube is installed in a well where steam will be injected to stimulate heavy or extra-heavy oil production. In this and other applications, installation and service loads can be quite high and during service it is common for the material to go into its plastic region. Thus, in order to satisfactorily withstand all of the various load requirements, the slotted steel tubing must consistently maintain minimum yield strength (YS) and minimum ultimate tensile strength (UTS) at room temperature as well as exhibit good and consistent YS and UTS behavior at temperatures up to about 350° C and good thermal fatigue (TF) behavior. In addition, the steel tubing must have good and consistent post-yield hardening modulus (PYHM) and limited post-yield relaxation (PYR) in the plastic region across all the temperature and strain ranges, as well as limited yield plateau (YP) at all service temperatures.

Conventionally, steel tubing used for thermal well applications is standard steel tubing as defined in the American Petroleum Institute (API) “Specification 5CT for Casing and Tubing” (API 5CT)—International Standard ISO 11960 “Petroleum and natural gas industries—Steel pipes for uses as casing or tubing for wells” (ISO 11960). While such steel tubing, may have a sufficient slot-ability it will not necessarily also have the very important thermo-mechanical properties desirable for that subset of casing that is employed as a slotted liner.

The two most common casing grades used for slotted liner are Grades K55 and L80. L80 has been shown to exhibit reasonably good slot-ability but most K55 steels have demonstrated unfavorable slot-ability. The unacceptable K55 materials are those that demonstrate a yield strength close to the lower end of the specified API range. Thus a critical feature of the invention is not exclusively improved slot-ability but that in combination with good thermo-mechanical properties, which simply are not found in L80 grades that do offer good slot-ability. As a consequence, slotting K55 materials to form slotted tubing has created problems such as low productivity rates, high tooling consumption, and significant operative delays, each of which increases the cost associated with slotting tubing. Accordingly, the present invention is directed toward remedying these problems, and in particular enables improved cutting mechanics and thermo-mechanical material properties for slotted casing liners used commonly in SAGD service. The modified steels illustrated herein have both surprisingly well-controlled mechanical properties and a much improved “slot-ability” that permits faster and less expensive slotting of casing liners using cutting blades.

Waid et al. (U.S. Pat. No. 4,256,517) discusses the control of certain material mechanical properties (specifically YjT ratio) by alloying a plain carbon-manganese steel solely with chromium, and then performing a specific heat treatment.

Watari (U.S. Pat. No. 5,922,145) discusses steels comprising S between 0.005% and 0.030% ; Mo max 0.50% and Mn up to 0.50%, but significantly lack of any understanding of advantage if Ti max were less than 0.02%, or even 0.035% . Watari emphasized Ti between 0.04% and 1.0%.

Okada et al. (U.S. Pat. No. 5,948,183) discusses steels having a “low yield ratio”, useful for oilfield tubular goods, comprising S less than 0.015% and Ti that only need to be less than about 0.20%. Only a single specification of a low yield ratio appears to be recognized in Okada et al. In contrast, the present invention specifically characterizes post-yield material properties by specifying hardening moduli at specific strain values as well as yield and ultimate strengths. The present application also teaches molybdenum as an agent able to improve needed mechanical properties. Okada et al. acknowledges the possibility of molybdenum but specifies that the low yield ratio they seek is achieved using other alloying elements.

Kimura (U.S. Pat. No. 6,869,489 B2) teaches molybdenum in an amount between 0.25% and 2.0% that also contains a carbide that has been precipitated using a heat treatment for spheroidizing to a particle size not larger than 1 μm., in order to achieve a higher machinability.

Ishida et al. (U.S. Pat. No. 6,761,853 B2 ) includes 27 Tables comparing various alloys of steels with and without various identified “machinabilty improving elements”. The present invention in contrast is concerned with the different problem of achieving enhanced slot-ability, while not compromising or degrading the critical performance attributes of good buckling resistance and good localization resistance, that are required for slotted tubing after it is placed into a difficult application, such as SAGD service.

The role of sulfur as to an expected effect on the “machinability” of steel is generally known. Most known prior art teaches away from using very small quantities of sulfur (i.e. 0.005 wt % to 0.030 wt %) where the problem is machinability and instead recommends a range generally greater than 0.03% and less than 0.50% . See, e.g. Riekels (US Pat. No. 4,255,188 ). Subsequent prior art suggests that lower amounts of sulfur (i.e. 0.01 wt % to 0.03 wt %) also may offer some improvement in machinability See, e.g., Yaguchi et al. (U.S. Pat. No. 6,579,385 B2).

### SUMMARY OF THE INVENTION

The present invention relates to steel tubing specifically manufactured to be slotted, yet to still retain or achieve high buckling resistance (or buckling “stability”) and high localization resistance. The steel tubing is capable of maintaining a minimum YS and a minimum UTS at room temperature as well as exhibit good and consistent YS and UTS behavior at temperatures up to about 350° C. In addition, the steel tubing has good TF behavior as well as a good and consistent PYHM and limited PYR in the plastic region all across the temperature and strain ranges, as well as limited YP all across the service temperature range. The present invention also relates to a process of manufacturing such steel tubing. A preferred staring material is a steel within the API classification of K55 steel, but that that has been heat treated so as to exhibit refined thermo-mechanical properties that make it more suitable for use as a thermal well tubular product. While slot-ability is important for the efficiency of the manufacturing process, adequate post-yield strain hardening is equally important to prevent buckling of a liner structure that has been placed in SAGD service, in the event each joint of liner is not exactly the same.

The prior art generally has looked at steel compositions with alloys of the type taught herein, but has not appreciated an unexpected result if the specific compositions as recited and claimed were subjected to a particular heat treatment cycle. The prior art failed to appreciate how to achieve surprisingly enhanced slot-ability in combination with high buckling resistance and high localization resistance, which according to the present invention appears to be a result of a microstructure having minimized fractions of bainite while also having a minimum fraction of 80% ferrite-perlite. Likewise, Research conducted in support of the present invention indicates that the presence of sulfur in the range of 0.005% to 0.03% by weight surprisingly improves the slot-ability response of K55 steels subjected to high post-yield hardening, without encroaching on the risk of any expectable corrosion cracking mechanism.

The two key aspects of good slotted liner performance in the oilfield, and especially SAGD service, are buckling resistance and localization resistance.

Thermo-mechanical properties desired preferably are evaluated by testing against a preferred specification, using Stress parameters of 0.5%, 1.35% and Strain parameters of 3.5%. A Zone 1 stress ratio (σ1.35%/σ0.5% ) at all temperatures should be ≧1.3 at static conditions. A Zone 2 stress ratio (σ3.5%/σ1.35% ) at all temperatures should be ≧1.2 at static conditions. Hardening modulus at 3.5% strain, at all temperatures, should be ≧800 MPa at static conditions. A Yield Plateau, at all temperatures above yield, should have a length ≦0.5% strain, at static conditions. Room temperature mechanical response should meet Yield Stress and Ultimate Stress requirements of the API K55 specification. For liners in SAGD service, the range of Yield Strengths is typically between 379 MPa and 551 MPa.

It is believed that buckling resistance for SAGD liners is largely associated with post-yield hardening behavior in the strain range of approximately 1.35% to 3.5% (“Zone 2”), whereas localization resistance is generally associated with hardening from yield to about 1.35% (“Zone 1”). Localization resistance is an indication of the liner's capacity to effectively accommodate axial variability in parameters associated with material properties, pipe section properties, and loading conditions, and should be considered a requirement for thermal liner.

A goal for a “zone 1 stress ratio” of 1.3%, as defined through liner analysis, is considered a target value. Prominent post-yield hardening behavior generally exhibited by the compared baseline Grade K55 samples at temperatures above 180° C. (generally 1.2% and greater at static conditions) is now believed likely to result in relatively good localization resistance.

Materials with substantial yield plateau are not believed to exhibit high zone 1 stress ratios. While plateaus were observed in baseline Grade K55 samples at room temperature, it appears that the present teachings about a need for localization resistance (and hence zone 1 hardening) is most important at temperatures near to or higher than the point of initial yielding. Hence, localization resistance is viewed as an important aspect of thermal liner design and it is expected that SAGD operators will look at localization resistance values as a key design feature

The steel tubing of the present invention is designed for use in various applications in the oil and gas industries, and in particular for steel tubing that first is slotted and then is used in the high temperature and high stress environment of SAGD service.

### BRIEF DESCRIPTION OF THE DRAWINGS

FIG. 1A is a photograph showing the microstructure of the steel of Comparative Example 2 at 200× magnification.

FIG. 1B is a photograph showing the microstructure of the steel of Comparative Example 2 at 500× magnification.

FIG. 2A is a photograph showing the microstructure of the steel of Comparative Example 1 at 200× magnification.

FIG. 2B is a photograph showing the microstructure of the steel of Comparative Example 1 at 500× magnification.

FIG. 3A is a photograph showing the microstructure of the steel of Comparative Example 3 at 200× magnification.

FIG. 3B is a photograph showing the microstructure of the steel of Comparative Example 3 at 500× magnification.

FIG. 4A is a photograph showing the microstructure of the steel of Example 1 at 200× magnification.

FIG. 4B is a photograph showing the microstructure of the steel of Example 1 at 500× magnification.

FIG. 5 is a photograph showing the microstructure of the steel of Comparative Example 5 at 2000× magnification.

FIG. 6 is a photograph showing the microstructure of the steel of Comparative Example 6 at 2000× magnification.

FIG. 7 is a photograph showing the microstructure of the steel of Example 2 at 1500× magnification.

FIG. 8 is a photograph showing the microstructure of the steel of Comparative Example 4 at 1500× magnification.

FIG. 9 is a photograph showing the microstructure of the steel of Comparative Example 7 at 1500× magnification.

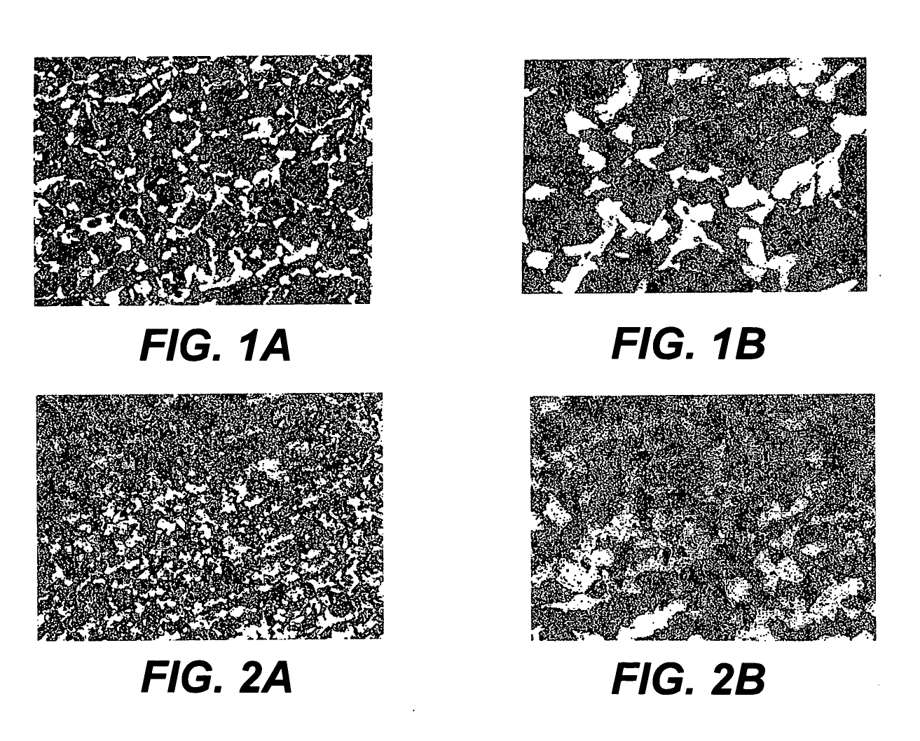

### DESCRIPTION OF PREFERRED EMBODIMENTS

Although the present invention is susceptible to embodiment in various forms, a presently preferred embodiment will be described hereinafter with the understanding that the present disclosure is to be considered an exemplification of the invention and is not intended to limit the invention to the specific embodiment illustrated.

The present invention relates to steel tubing with enhanced slot-ability for use in various applications in the oil and gas industries. More particularly, the invention relates to steel tubing having a specific chemical composition and a ferrite plus pearlite or a ferrite plus bainite-pearlite microstructure and a process for manufacturing the steel tubing.

As noted above, while some steel tubing under the broad API 5CT standard material may not be difficult to slot, the most common liner Grades K55 and L80 present disadvantages. As a result, slotting Grade K55 liners involves long machining times per piece, high tooling consumption and operative delays. All of these effectively increase the cost of slotting a steel tube. To help reduce the cost of slotting steel tubing, the present invention is directed to steel tubing, and a method of manufacturing the steel tubing, having both enhanced slot-ability characteristics and superior thermo-mechanical properties.

In addition to reducing the cost associated with slotting tubing, production of a steel tube with enhanced slot-ability characteristics for use in oil and gas wells also has the benefit of helping to give well operators peace of mind. Use of such steel can help assure well operators that the steel tubing used in a particular well will cope with all of the loading conditions expected to occur during the life of the well, including operative and shut down conditions. Moreover, thermal well designs and operations frequently require materials to operate in their plastic regions in temperatures ranging from room temperature to about 350° C. The steel tubing of the present invention has been designed in light of the operative conditions of the steel tubing in such applications, and has more restricted and stable behavior for key variables such as YS, UTS, PYHM, PYR, TF and YP.

The steel tubing of the present invention is a result of intensive research by the inventors. During the course of the research, the inventors realized that the addition of small quantities of sulfur, combined with the standard hot rolling process and a specifically defined heat treatment cycle, produced steel tubing with enhanced slot-ability characteristics. Additionally, small additions of Mo have shown to be beneficial to enhancing and making more stable properties such as YS, UTS, PYHM, PYR, TF and YP over the material service operative range.

The process for making the steel tubing of the present invention consists in making billets of acceptable steel, as by cutting steel bars into billets, and hot rolling the billets into tubes. The tubes are then air cooled to room temperature. Then, in a final heat treatment process, the tubes are heated to approximately 40° C. above the corresponding AC3 temperature and soaked at that temperature for a predetermined period of time, after which the tubes are air cooled back to room temperature.

The preferred method for conducting the final heat treatment cycle involves linearly heating the tubes from room temperature to approximately 40° C. above the corresponding AC3 temperature over the course of about 30 minutes. Once at 40° C. above the corresponding AC3 temperature, the tubes are soaked for about 10 minutes. Finally, the tubes are air cooled back down to room temperature, a process that takes approximately 80 minutes.

In a preferred embodiment, a K55 steel having a steel chemistry as taught herein first is heated to above the eutectoid temperature in order to effectively create a uniform austenite structure. However, that austenite structure is unstable at lower temperatures, so as the steel is cooled the microstructure will change. The resultant microstructure is dependent upon the rate at which the steel cools after the soaking period. In the preferred embodiment the desired microstructure was achieved using 40° C. above the corresponding AC3 temperature, a 10 minute soak, and a target cooling time of 80 minutes. Workers of ordinary skill could employ isothermal transformation diagrams to decide on a range of useful cooling paths that will achieve the desired microstructure (minimized fractions of bainite and a minimum fraction of 80% ferrite-perlite. Microstructure) as steel chemistry, AC3 temperatures, soaking time and tubing sizes vary.

The hardening behavior of a material correlates to the slot-ability behavior and hardening behavior also determines effectiveness of a material's thermo-mechanical behavior in SAGD service. Concerning desired thermo-mechanical material properties, there is a distinction between the broad definition of the K55 grade steel defined in API SIT and the typical range of properties exhibited by the K55 grade steels in the preferred embodiment. API SIT defines K55 grade steel mechanically by setting a range for yield strengths between 55 ksi and 80 ksi and a minimum ultimate tensile strength of 95 ksi. The preferred embodiment uses a K55 steel with a static yield strength at room temperature that is typically lower than 65 ksi. Given that the yield strength of preferred material is at the low end of the API range, there will be significantly more hardening.

With the above-described process for producing steel tubing having the chemical composition described below, the resulting steel tubing has a ferrite plus pearlite or a ferrite plus bainte-pearlite microstructure. It is this combination of a specific chemical composition along with the above-noted microstructures that renders the steel tubing having enhanced slot-ability characteristics of the present invention.

As noted-above, the defined steel chemistry allows for the production of the desired steel tubing after the hot rolling and heat treatment operations. In particular, the carbon content helps achieve a minimum specified strength level controlled by a minimum YS and also minimum TS. The addition of micro-alloying elements, such as titanium, contributes to the strength level of the steel tubing and helps give the steel tubing a minimum desired toughness. Molybdenum contributes to achieving the desired strength level of the steel tubing and helps give the steel better and more stable mechanical behavior at warm temperatures. Further, a controlled range of sulfur causes enhanced slot-ability performance without a compromising risk of environmental cracking in the expected service environment. That is, small additions of sulfur can, on the one hand, help to improve steel machinability. On the other hand, too much sulfur may result in steel tubing that is more prone to cracking due to hydrogen embrittlement when hydrogen is present in the environment, something that typically happens in casing and tubing applications for oil and gas wells. Thus, the range for sulfur listed below represents a compromise between the desire to enhance machinability and the desire to prevent cracking and hydrogen embrittlement. Note that something similar would happen if Ti levels in the steel tubing are too high.

The preferred ranges (in weight %) of the elements making up the chemical composition of the steel tubing of the present invention are as follows:
Carbon: 0.05-0.40
Manganese: 0.50-1.60
Phosphorus: maximum of about 0.020
Sulfur: 0.005-0.030
Silicon: maximum of about 0.40
Chromium: maximum of about 0.50
Molybdenum: maximum of about 0.50
Niobium: maximum of about 0.050
Titanium: maximum of about 0.035
Vanadium: maximum of about 0.090
Copper: maximum of about 0.300
Aluminum: maximum of about 0.040

More preferred for the ranges (in weight %) of the elements making up the chemical composition of the steel tubing of the present invention are as follows:
Carbon: 0.28-0.40
Manganese: 1.20-1.45
Phosphorus: maximum of about 0.020
Sulfur: 0.015-0.030
Silicon: maximum of about 0.40
Chromium: maximum of about 0.50
Molybdenum: maximum of about 0.20
Niobium: maximum of about 0.010
Titanium: maximum of about 0.020
Vanadium: maximum of about 0.020
Copper: maximum of about 0.250
Aluminum: maximum of about 0.035

Even more preferred for the ranges (in weight %) of the elements making up the chemical composition of the steel tubing of the present invention are as follows:
Carbon: 0.31-0.34
Manganese: 1.25-1.40
Phosphorus: maximum of about 0.020
Sulfur: 0.015-0.025
Silicon: maximum of about 0.40
Chromium: maximum of about 0.50
Molybdenum: maximum of about 0.11
Niobium: maximum of about 0.005
Titanium: maximum of about 0.015
Vanadium: maximum of about 0.010
Copper: maximum of about 0.250
Aluminum: maximum of about 0.025

Steel tubing having a chemical composition as described above and which as been subjected to the above-described heat treatment process preferably will preferably have the following properties:
Minimum yield strength at room temperature of 55 ksi (379.2 MPa);
Maximum yield strength at room temperature of 80 ksi (551.6 MPa);
Minimum ultimate tensile strength at room temperature of 95 ksi (655 MPa);
Minimum elongation at room temperature of 20%; and
Minimum impact toughness at room temperature of 30 J (on a longitudinal full-sized sample).

The steel tubing also preferably exhibits reduced/controlled yield strength derating at temperatures up to 350° C. Specifically, the ratio of actual material yield strength at a given temperature versus original material yield strength at room temperature is preferably greater than 0.75 at 350° C. and greater than 0.80 at 180° C. Further, the steel tubing preferably exhibits reduced/controlled tensile strength derating at temperatures up to 350° C. Specifically, the ratio of actual material tensile strength at the given temperature versus original material tensile strength at room temperature is preferably greater than 0.92 at 350° C., greater than 1.06 at 180° C., and greater than 1.1 at 230° C. and 280° C. Additionally, the steel tubing preferably exhibits reduced/controlled post-yield material relaxation at temperatures up to 350° C. Specifically, the ratio of material static yield strength versus material yield strength is preferably greater than 0.83 at any strain level up to 4% and temperature up to 350° C. Further, the steel tubing preferably exhibits a minimum post-yield hardening modulus at different temperatures and strain levels up to 350° C., exhibits hardening modulus greater than 7,500 MPa at 1.5% strain at any temperature up to 350° C., and exhibits a hardening modulus greater than 3,500 MPa at 4% strain at any temperature up to 350° C.

Other chemical compositions and/or manufacturing routes would be able to give steel tubing having a ferrite-pearlite microstructure, but such methods would also result in higher fractions of bainite and other secondary structures, as well as no (or less) homogeneous distributions. These are factors that would work against the slot-ability of the steel tubing.

To demonstrate the enhanced slot-ability characteristics of the steel tubing of the present invention, the inventors performed the below-described comparative tests.

Comparative Test 1

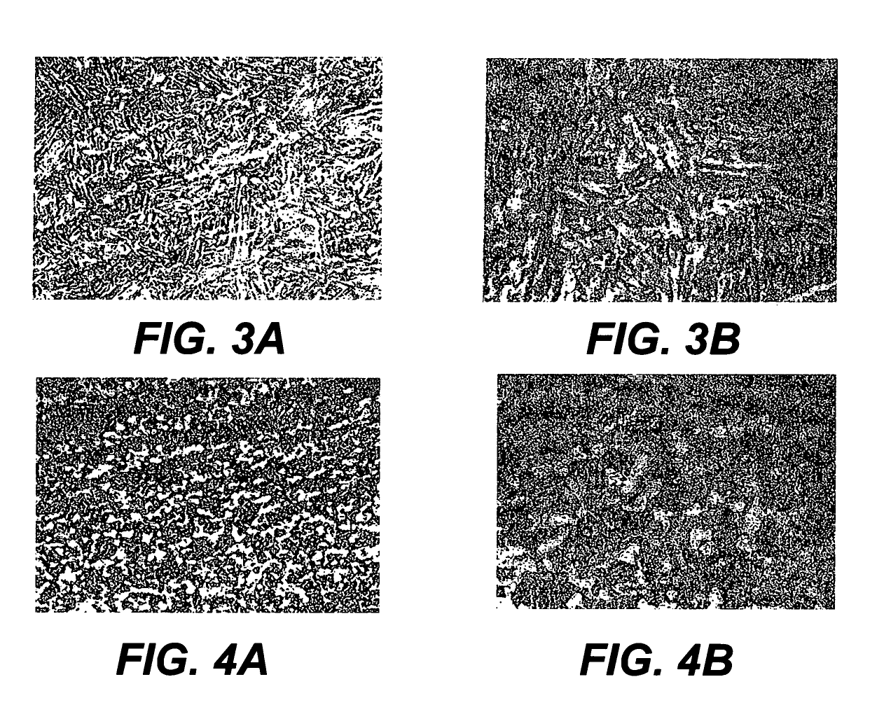

Four steel tubes having the chemical compositions and microstructures shown in TABLE 1, below, were prepared. All four steel tubes had an outer diameter of 244.50 mm and a wall thickness of 10.03 mm. Example 1 (the steel produced according to the present invention) and Comparative Example 1 were normalized. That is, the steel tubes of Example 1 and Comparative Example 1 were subjected to the heat treatment cycle described above. The steel tubes of Comparative Examples 2 and 3 were left in their as rolled states. The microstructure of the steel tubes of Example 1 may be seen in FIGS. 4A and 4B. The microstructure of the steel tubes of Comparative Example 1 may be seen in FIGS. 2A and 2B. The microstructure of the steel tubes of Comparative Example 2 may be seen in FIGS. in 1A and 1B. The microstructure of steel tubes of Comparative Example 3 may be seen in FIGS. 3A and 3B.

TABLE 1

| | | | | Comparative |
|---|---|---|---|---|
| | Example 1 | Comparative | Comparative | Example 3 |
| | Ferrite plus | Example 1 | Example 2 | Ferrite plus |
| | bainite- | Ferrite | Ferrite | mainly |
| Microstructure | pearlite | pearlite | pearlite | bainite |
| % C × 100 | 29 | 32 | 32 | 29 |
| % Mn × 100 | 130 | 134 | 135 | 134 |
| % S × 1000 | 13 | 2 | 1 | 13 |
| % P × 1000 | 12 | 13 | 14 | 14 |
| % Si × 100 | 29 | 37 | 37 | 30 |
| % Ni × 100 | 5 | 5 | 6 | 5 |
| % Cr × 100 | 22 | 4 | 4 | 22 |
| % Mo × 100 | 15 | 9 | 9 | 15 |
| % V × 1000 | 3 | 2 | 0 | 0 |
| % Cu × 100 | 9 | 8 | 8 | 9 |
| % Sn × 1000 | 11 | 9 | 10 | 12 |
| % As × 1000 | 6 | 4 | 0 | 0 |
| % Al × 1000 | 20 | 21 | 17 | 21 |
| % Ca ppm | 19 | 18 | 13 | 14 |
| % Nb × 1000 | 1 | 1 | 0 | 2 |
| % Ti × 1000 | 2 | 12 | 12 | 2 |
| % B ppm | 1 | 1 | 0 | 1 |
| % Ceq × 100 | 59.06 | 57.84 | 58.03 | 59.67 |
| % Pcm × 100 | 39.13 | 41.24 | 41.28 | 39.33 |

The following tests were performed to characterize the steel tubing of Example 1 and Comparative Examples 1-3:
Tensile tests—API longitudinal full-size standard (38 mm) specimens were machined from each sample and tested.
Hardness Rockwell C tests—The harness tests were performed in four different positions: at 0+, 90+, 180+ and 270°, with nine indentations in each position, which correspond to three indentations (external, internal and mid-wall) per position.
Impact transition curves—From each sample, five sets of three Charpy specimens, CL and LC 10x7.5 mm, were performed and tested at −60°, −40°, −20°, 0° and 21° C. The shear area was determined using the direct measurement method (ASTM E 23).
Machinability tests—Two different tests were carried out. Both tests were performed using GLOBUS HSS 2′¾″×0.0018″×1″/72T model saws. The first test consisted of cutting slots of 500 mm of length while the second test consisted of cutting slots with 5 mm of depth and 500 mm of length. In both cases, the relative machinability was measured by the total length of slotting made with each saw. Each saw was used until it was unusable or until it was broken. In the case of Comparative Examples 1 and 3, the feed rate was reduced from the 250 mm/min used in the other samples to a rate of 180 mm/min to prevent the saws from continually breaking.

The results of the above-described tests are depicted in Table 2, below.

TABLE 2

| | | | Comparative | Comparative | Comparative |
|---|---|---|---|---|---|
| | | Example 1 | Example 1 | Example 2 | Example 3 |
| Mechanical | YS (MPa) | 461 | 455 | 444 | 536 |
| Properties | UTS (MPa) | 705 | 691 | 709 | 738 |
| | YS/UTS | 0.65 | 0.66 | 0.63 | 0.73 |
| | Elongation % | 27.4 | 30.3 | 36.3 | 23.0 |
| Hardness | HRC | 17 | 13 | 15 | 19 |
| Toughness | Energy (J) at | 29.7 | 59.0 | 26.7 | 14.0 |
| | 20° C., LC | | | | |
| | Shear Area (%) | 41.7 | 53.3 | 27.3 | 15.7 |
| | at 20° C., LC | | | | |
| | Energy (J) at | 24.3 | 47.7 | 36.0 | 12.7 |
| | 20° C., CL | | | | |
| | Shear Area (%) | 46 | 49.7 | 35.3 | 10.7 |
| | at 20° C., CL | | | | |
| Machinability | Slotting | 8.00 | 5.50 | 7.00 | 5.72 |
| (First Trial) | Distance (m) | | | | |
| | Cutting Speed | 80 | 80 | 80 | 80 |
| | (m/min) | | | | |
| | Feed Rate | 69 | 69 | 69 | 69 |
| | (mm/min) | | | | |
| Machinability | Slotting | 28.00 | 14.20 | 15.00 | 14.30 |
| (Second Trial) | Distance (m) | | | | |
| | Cutting Speed | 80 | 80 | 80 | 80 |
| | (m/min) | | | | |
| | Feed Rate | 250 | 180 | 250 | 180 |
| | (mm/min) | | | | |

Note that the HRC hardness values listed in TABLE 2 are a general average, which was calculated as follows. First, the average of the individual external, internal and mid-wall measurements for each quadrant was calculated. Next, the average external, internal and mid-wall measurements for each quadrant were averaged to generate a general external, internal and mid-wall HRC value. Then, the general external, internal and mid-wall HRC values were averaged together to generate the HRC value listed in TABLE 2.

The toughness values listed in TABLE 2 represent the toughness values at the transition temperature of the steel tubing of Example 1 and Comparative Examples 1-3. The transition temperature was determined by examining the values of the energy and shear area at each of the four measured temperatures. TABLE 3 represents the Charpy transition curves for the 10×7.5-LC specimens. TABLE 4 represents the Charpy transtion curves for the 10×7.5-CL specimens.

TABLE 3

| | Temp | Energy (Joules) | | | | Shear Area (%) | | | |
|---|---|---|---|---|---|---|---|---|---|
| Example | (° C.) | 1 | 2 | 3 | Average | 1 | 2 | 3 | Average |
| Example 1 | −60 | 8 | 8 | 7 | 7.7 | 0 | 0 | 0 | 0.0 |
| | −40 | 10 | 11 | 9 | 10.0 | 8 | 9 | 8 | 8.3 |
| | −20 | 14 | 11 | 10 | 11.7 | 18 | 16 | 13 | 15.7 |
| | 0 | 25 | 17 | 22 | 21.3 | 31 | 22 | 29 | 27.3 |
| | 20 | 29 | 30 | 30 | 29.7 | 38 | 43 | 44 | 41.7 |
| Comparative | −60 | 4 | 10 | 8 | 7.3 | 0 | 0 | 0 | 0.0 |
| Example 1 | −40 | 16 | 8 | 16 | 13.3 | 7 | 0 | 7 | 4.7 |
| | −20 | 31 | 22 | 25 | 26.0 | 23 | 18 | 19 | 20.0 |
| | 0 | 39 | 40 | 41 | 40.0 | 35 | 33 | 37 | 35.0 |
| | 20 | 62 | 57 | 58 | 59.0 | 52 | 50 | 58 | 53.3 |
| Comparative | −60 | 3 | 2 | 4 | 3.0 | 0 | 0 | 0 | 0.0 |
| Example 2 | −40 | 3 | 3 | 3 | 3.0 | 0 | 0 | 0 | 0.0 |
| | −20 | 6 | 23 | 6 | 11.7 | 7 | 16 | 5 | 9.3 |
| | 0 | 32 | 29 | 8 | 23.0 | 28 | 22 | 15 | 21.7 |
| | 20 | 25 | 17 | 38 | 26.7 | 26 | 16 | 40 | 27.3 |
| Comparative | −60 | 4 | 6 | 6 | 5.3 | 0 | 0 | 0 | 0.0 |
| Example 3 | −40 | 6 | 4 | 6 | 5.3 | 0 | 0 | 0 | 0.0 |
| | −20 | 9 | 7 | 11 | 9.0 | 0 | 0 | 0 | 0.0 |
| | 0 | 9 | 9 | 13 | 10.3 | 8 | 7 | 12 | 9.0 |
| | 20 | 15 | 13 | 14 | 14.0 | 17 | 15 | 15 | 15.7 |

TABLE 4

| | Temp | Energy (Joules) | | | | Shear Area (%) | | | |
|---|---|---|---|---|---|---|---|---|---|
| Example | (° C.) | 1 | 2 | 3 | Average | 1 | 2 | 3 | Average |
| Example 1 | −60 | 7 | 7 | 7 | 7.0 | 0 | 0 | 0 | 0.0 |
| | −40 | 10 | 12 | 15 | 12.3 | 8 | 8 | 11 | 9.0 |
| | −20 | 13 | 10 | 14 | 12.3 | 20 | 17 | 22 | 19.7 |
| | 0 | 18 | 18 | 15 | 17.0 | 31 | 33 | 29 | 31.0 |
| | 20 | 27 | 23 | 23 | 24.3 | 50 | 45 | 43 | 46.0 |
| Comparative | −60 | 11 | 4 | 4 | 6.3 | 0 | 0 | 0 | 0.0 |
| Example 1 | −40 | 18 | 19 | 19 | 18.7 | 10 | 10 | 10 | 10.0 |
| | −20 | 26 | 19 | 25 | 23.3 | 16 | 14 | 18 | 16.0 |
| | 0 | 33 | 32 | 37 | 34.0 | 35 | 30 | 32 | 32.3 |
| | 20 | 47 | 45 | 51 | 47.7 | 50 | 44 | 55 | 49.7 |
| Comparative | −60 | 3 | 3 | 2 | 2.7 | 0 | 0 | 0 | 0.0 |
| Example 2 | −40 | 4 | 3 | 3 | 3.3 | 0 | 0 | 0 | 0.0 |
| | −20 | 8 | 9 | 9 | 8.7 | 8 | 9 | 8 | 8.3 |
| | 0 | 13 | 23 | 19 | 18.3 | 13 | 23 | 20 | 18.7 |
| | 20 | 33 | 39 | 36 | 36.0 | 35 | 37 | 34 | 35.3 |
| Comparative | −60 | 4 | 3 | 5 | 4.0 | 0 | 0 | 0 | 0.0 |
| Example 3 | −40 | 5 | 4 | 5 | 4.7 | 0 | 0 | 0 | 0.0 |
| | −20 | 7 | 9 | 8 | 8.0 | 0 | 0 | 0 | 0.0 |
| | 0 | 12 | 8 | 8 | 9.3 | 10 | 8 | 7 | 8.3 |
| | 20 | 13 | 11 | 14 | 12.7 | 11 | 9 | 12 | 10.7 |

From TABLE 3 and TABLE 4, it is apparent that no specimen had 100% of shear area at room temperature. The maximum value for an LC specimen was 53% and the maximum value for a CL specimen was 50%, both of which correspond to Example 1. Thus, the transition temperature (as measured by 50% of the shear area) was about 20° C. for Example 1.

Also, as shown in TABLE 2, Example 1 had the best results for both the first trial (8.0 m) and the second trial (28.0 m). In other words, the steel tubing of Example 1 had enhanced slot-ability as compared to the steel tubing of Comparative Examples 1-3.

### Comparative Test 2

A comparative test was performed using steel tubing have the below described composition:

TABLE 5

| | | Comparative | Comparative | Comparative | Comparative |
|---|---|---|---|---|---|
| Microstructure | Example 2 | Example 4 | Example 5 | Example 6 | Example 7 |
| % C × 100 | 33 | 32 | 21 | 26 | 14 |
| % Mn × 100 | 130 | 134 | 135 | 54 | 125 |
| % S × 1000 | 16 | 1.2 | 1.2 | 1 | 1 |
| % P × 1000 | 17 | 11 | 13 | 7 | 12 |
| % Si × 100 | 33 | 35 | 30 | 26 | 29 |
| % Ni × 100 | 5 | 4 | 4 | 4.5 | 5 |
| % Cr × 100 | 4 | 3 | 25 | 91 | 20 |
| % Mo × 100 | 10 | 10 | 13 | 39 | 7 |
| % V × 1000 | 2 | 3 | 3 | 4 | 44 |
| % Cu × 100 | 10 | 8 | 10 | 8.5 | 20 |
| % Sn × 1000 | 9 | 9 | 12 | 7 | 7 |
| % As × 1000 | 6 | 4 | 5 | 6 | 4 |
| % Al × 1000 | 20 | 17 | 24 | 28 | 22 |
| % Ca ppm | 11 | 9 | 11 | — | 12 |
| % Nb × 1000 | 1 | 1 | 28 | 34 | 15 |
| % Ti × 1000 | 11 | 12 | 4 | 2 | 1 |
| % B × 1000 | — | — | — | — | — |

Tests were performed at varying temperature (25° C., 180° C., 230° C., 280° C. and 330° C.) and at a strain rate of 1.67×10⁻⁵ sec⁻¹ (10⁻³ min⁻¹). Two tests were performed in each condition. The strain measurement was performed with a longitudinal LVDT gauge within the reduced section. The stress relaxation response was measured at three (3) hold points (1 hour per hold point) at approximately 1%, 3% and 5% strain. At each hold step the applied strain was held as constant as possible and the stress and strain were monitored with time. Tests were continued up to specimen necking.

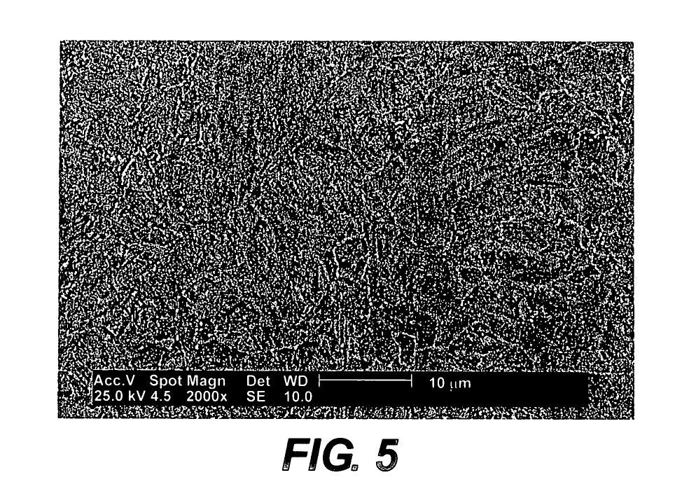

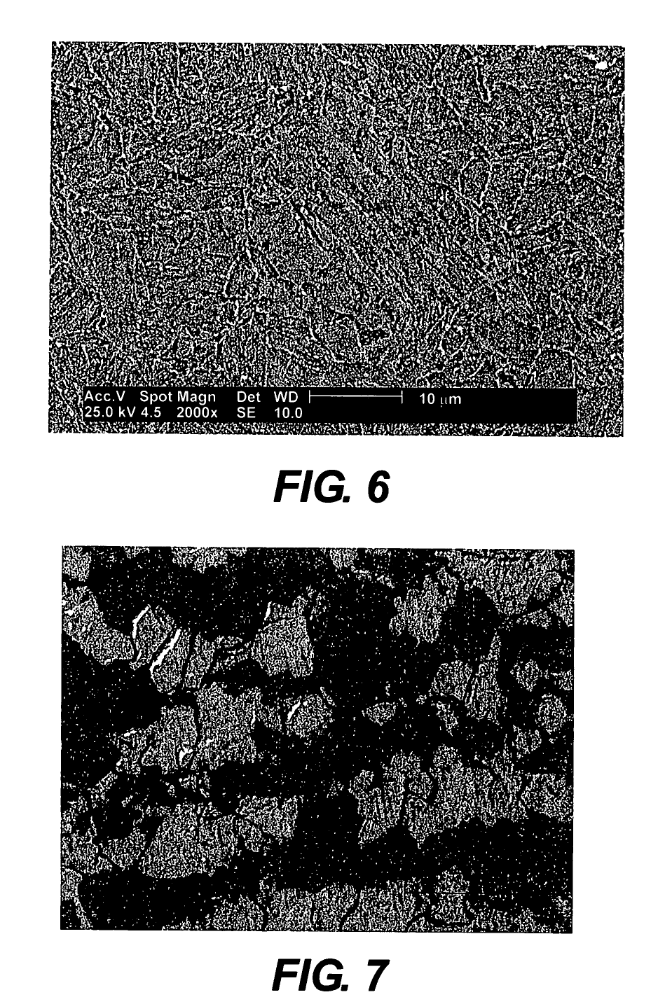

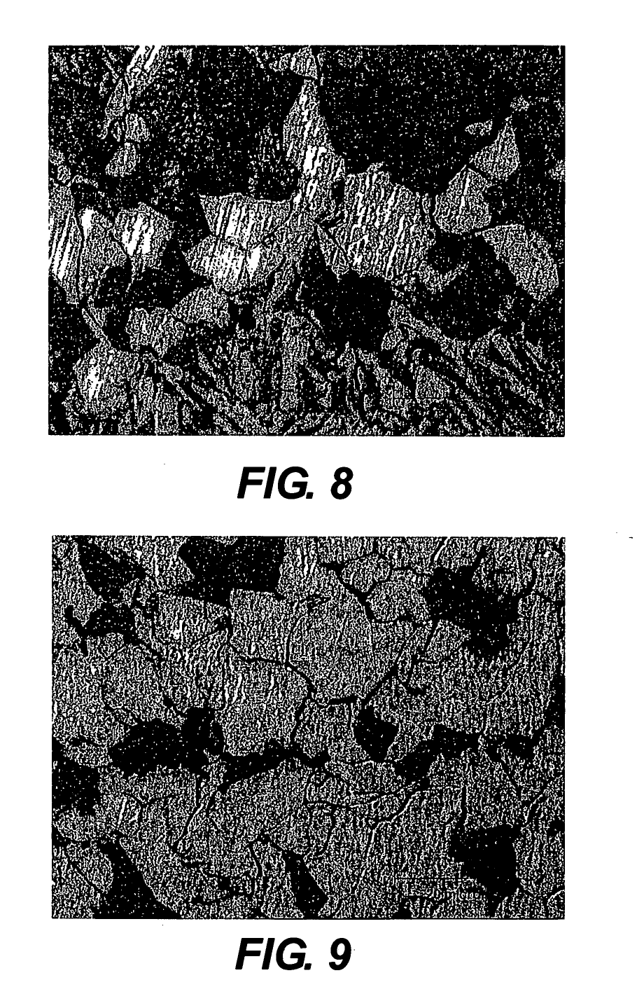

The tests results are summarized in TABLES 6-10 below. The tables include yield stress (σ), quasi static yield (σ_{qs}), delta yield strain (Δσ) and modulus of strain hardening (dσ/dε) at strains of 0.5%, 1.5% and 4%. In addition, the yield strength at 0.2% offset (YS_{0.2%}), the ultimate tensile strength (UTS) and the hardening index (n) were calculated. With the exception of Comparative Example 7 at 330° C., the results presented below represent the average of two tests performed in each condition. In that regard, the estimated errors in the duplicated tests are ±0.1 for n, ±10 MPa for YS, ±10 MPa for UTS, and ±20 MPa for Δσ. The microstructure of the steel of Example 2 may be seen in FIG. 7. The microstructure of the steel of Comparative Example 4 may be seen in FIG. 8. The microstructure of the steel of Comparative Example 5 may be seen in FIG. 5. The microstructure of the steel of Comparative Example 6 may be seen in FIG. 6. The microstructure of the steel of Comparative Example 7 may be seen in FIG. 9.

TABLE 6

| | | | σ | σ_{qs} | Δσ | dσ/dε | | | |
|---|---|---|---|---|---|---|---|---|---|
| Steel | Temp | Strain | (MPa) | (MPa) | (σ-σ_{qs}) | (MPa) | n | YS_{0.2%} | UTS |
| Example | 25° C. | 0.5% | 450 | 390 | 60 | — | 0.22 | 460 | 683 |
| 2 | | 1.5% | 515 | 450 | 65 | 7550 | | | |
| | | 4% | 650 | 565 | 85 | 3575 | | | |
| | 180° C. | 0.5% | 400 | 350 | 50 | 22400 | 0.28 | 395 | 729 |
| | | 1.5% | 520 | 455 | 65 | 9700 | | | |
| | | 4% | 680 | 595 | 85 | 4750 | | | |
| | 230° C. | 0.5% | 405 | 340 | 65 | 22675 | 0.28 | 380 | 780 |
| | | 1.5% | 550 | 460 | 90 | 10250 | | | |
| | | 4% | 720 | 600 | 120 | 5050 | | | |
| | 280° C. | 0.5% | 375 | 315 | 60 | 24000 | 0.32 | 350 | 772 |
| | | 1.5% | 500 | 425 | 75 | 10675 | | | |
| | | 4% | 690 | 580 | 110 | 5525 | | | |
| | 330° C. | 0.5% | 370 | 315 | 55 | 21450 | 0.29 | 350 | 704 |
| | | 1.5% | 490 | 435 | 55 | 9475 | | | |
| | | 4% | 660 | 580 | 80 | 4775 | | | |

TABLE 7

| | | | σ | σ_{qs} | Δσ | dσ/dε | | | |
|---|---|---|---|---|---|---|---|---|---|
| Steel | Temp | Strain | (MPa) | (MPa) | (σ-σ_{qs}) | (MPa) | n | YS_{0.2%} | UTS |
| Comparative | 25° C. | 0.5% | 475 | 425 | 50 | — | 0.22 | 465 | 729 |
| Example 4 | | 1.5% | 570 | 515 | 55 | 8350 | | | |
| | | 4% | 705 | 635 | 70 | 3875 | | | |
| | 180° C. | 0.5% | 465 | 405 | 60 | 23250 | 0.25 | 405 | 750 |
| | | 1.5% | 580 | 520 | 60 | 9675 | | | |
| | | 4% | 740 | 660 | 80 | 4625 | | | |
| | 230° C. | 0.5% | 470 | 400 | 70 | 22550 | 0.24 | 435 | 812 |
| | | 1.5% | 595 | 520 | 75 | 9525 | | | |
| | | 4% | 765 | 660 | 105 | 4600 | | | |
| | 280° C. | 0.5% | 445 | 380 | 65 | 23150 | 0.26 | 415 | 793 |
| | | 1.5% | 550 | 475 | 75 | 9525 | | | |
| | | 4% | 745 | 640 | 105 | 4850 | | | |
| | 330° C. | 0.5% | 415 | 360 | 55 | 21575 | 0.26 | 390 | 717 |
| | | 1.5% | 525 | 450 | 75 | 9100 | | | |
| | | 4% | 685 | 585 | 100 | 4450 | | | |

TABLE 8

| | | | σ | σ_{qs} | Δσ | dσ/dε | | | |
|---|---|---|---|---|---|---|---|---|---|
| Steel | Temp | Strain | (MPa) | (MPa) | (σ-σ_{qs}) | (MPa) | n | YS_{0.2%} | UTS |
| Comparative | 25° C. | 0.5% | 655 | 585 | 70 | — | 0.13 | 660 | 726 |
| Example 5 | | 1.5% | 645 | 565 | 80 | 5600 | | | |
| | | 4% | 730 | 640 | 90 | 2375 | | | |
| | 180° C. | 0.5% | 590 | 510 | 80 | — | 0.13 | 575 | 736 |
| | | 1.5% | 645 | 560 | 85 | 5600 | | | |
| | | 4% | 735 | 635 | 100 | 2400 | | | |
| | 230° C. | 0.5% | 585 | 490 | 95 | 17550 | 0.15 | 575 | 774 |
| | | 1.5% | 665 | 560 | 105 | 6650 | | | |
| | | 4% | 760 | 645 | 115 | 2850 | | | |
| | 280° C. | 0.5% | 590 | 485 | 105 | 16525 | 0.14 | 580 | 760 |
| | | 1.5% | 650 | 545 | 105 | 6075 | | | |
| | | 4% | 745 | 620 | 125 | 2600 | | | |
| | 330° C. | 0.5% | 550 | 450 | 100 | 13200 | 0.12 | 560 | 693 |
| | | 1.5% | 630 | 500 | 130 | 5050 | | | |
| | | 4% | 700 | 560 | 140 | 2100 | | | |

TABLE 9

| | | | σ | σ_{qs} | Δσ | dσ/dε | | | |
|---|---|---|---|---|---|---|---|---|---|
| Steel | Temp | Strain | (MPa) | (MPa) | (σ-σ_{qs}) | (MPa) | n | YS_{0.2%} | UTS |
| Comparative | 25° C. | 0.5% | 650 | 600 | 50 | — | 0.13 | 645 | 727 |
| Example 6 | | 1.5% | 645 | 590 | 55 | 5600 | | | |
| | | 4% | 740 | 670 | 70 | 2400 | | | |
| | 180° C. | 0.5% | 585 | 525 | 60 | — | 0.14 | 570 | 748 |
| | | 1.5% | 655 | 585 | 70 | 6100 | | | |
| | | 4% | 750 | 665 | 85 | 2625 | | | |
| | 230° C. | 0.5% | 575 | 500 | 75 | 17250 | 0.15 | 575 | 776 |
| | | 1.5% | 670 | 580 | 90 | 6700 | | | |
| | | 4% | 765 | 675 | 90 | 2875 | | | |
| | 280° C. | 0.5% | 545 | 465 | 80 | 17450 | 0.16 | 550 | 744 |
| | | 1.5% | 630 | 530 | 100 | 6725 | | | |
| | | 4% | 735 | 620 | 115 | 2950 | | | |
| | 330° C. | 0.5% | 545 | 455 | 90 | 14175 | 0.13 | 530 | 712 |
| | | 1.5% | 620 | 520 | 100 | 5375 | | | |
| | | 4% | 710 | 590 | 120 | 2300 | | | |

TABLE 10

| | | | σ | σ_{qs} | Δσ | dσ/dε | | | |
|---|---|---|---|---|---|---|---|---|---|
| Steel | Temp | Strain | (MPa) | (MPa) | (σ-σ_{qs}) | (MPa) | n | YS_{0.2%} | UTS |
| Comparative | 25° C. | 0.5% | 400 | 345 | 55 | — | 0.24 | 405 | 550 |
| Example 7 | | 1.5% | 405 | 340 | 65 | 6475 | | | |
| | | 4% | 500 | 430 | 70 | 3000 | | | |
| | 180° C. | 0.5% | 335 | 295 | 40 | — | 0.28 | 340 | 560 |
| | | 1.5% | 375 | 325 | 50 | 7000 | | | |
| | | 4% | 490 | 425 | 65 | 3425 | | | |
| | 230° C. | 0.5% | 315 | 265 | 50 | 15750 | 0.27 | 315 | 575 |
| | | 1.5% | 410 | 340 | 70 | 7075 | | | |
| | | 4% | 530 | 440 | 90 | 3375 | | | |
| | 280° C. | 0.5% | 315 | 255 | 60 | 17000 | 0.27 | 295 | 607 |
| | | 1.5% | 420 | 345 | 75 | 7550 | | | |
| | | 4% | 540 | 440 | 100 | 3650 | | | |
| | 330° C. | 0.5% | 320 | 260 | 60 | 16650 | 0.26 | 300 | 597 |
| | | 1.5% | 410 | 345 | 65 | 7100 | | | |
| | | 4% | 535 | 445 | 90 | 3475 | | | |

The results of the comparative test show that the strain and hardening effect is higher in Example 2 and Comparative Example 4, and particularly Example 2, than in the other Comparative Examples. This is explained by considering the lower dislocation levels in Example 2 and Comparative Example 4 (ferrite-pearlite structure vs. tempered martensite).

Additionally, Example 2 and Comparative Example 4 have nearly the same chemical composition and yield strength values, but Comparative Example 4 has coarser ferritic grain size and some acicular shaped grains. Because yield strength depends directly on the square root of the dislocation density, and inversely on the square root of the ferritic grain size, dislocation density should be higher in Comparative Example 4 than in Example 2. This dislocation density is the reason why the aging effect is lower in Comparative Example 4.

Further, the stress relaxation is more pronounced at higher strains and temperatures. This is reasonable since higher strains imply a high level of dislocations to be recovered and the mobility of the dislocations increases with temperature. There is not a clear difference between the six analyzed steels in stress relaxation behavior.

While preferred embodiments of the invention have been shown and described, it is to be understood that the invention is to be solely defined by the scope of the appended claims.

We claim:

1. A steel tubing adapted to enable substantial post-yield hardening behavior across a temperature range between room temperature and 350° C. while providing good slot-ability, buckling resistance and localization resistance, wherein the steel consists essentially of:
about 0.05 to about 0.40 wt. % carbon;
about 0.50 to about 1.60 wt. % manganese;
a maximum of about 0.020 wt. % phosphorous;
about of 0.005 to about 0.030 wt. % sulfur;
a maximum of about 0.40 wt. % silicone;
a maximum of about 0.50 wt. % chromium;
a maximum of about 0.50 wt. % molybdenum;
a maximum of about 0.050 wt. % niobium;
a maximum of about 0.035 wt. % titanium;
a maximum of about 0.090 wt. % vanadium;
a maximum of about 0.30 wt. % copper; and
a maximum of about 0.040 wt. % aluminum,
wherein the steel tubing has a post-yield hardening microstructure comprising either ferrite plus pearlite or ferrite plus bainite-pearlite.

2. The steel tubing according to claim 1, having at least one of the following properties:
Minimum yield strength at room temperature of 55 ksi (379.2 MPa);
Maximum yield strength at room temperature of 80 ksi (551.6 MPa);
Minimum ultimate tensile strength at room temperature of 95 ksi (655 MPa);
Minimum elongation at room temperature of 20%; and
Minimum impact toughness at room temperature of 30 J (on a longitudinal full-sized sample).

3. The steel tubing according to claim 1, having at least one of the following properties:
a ratio of actual material yield strength at a given temperature versus original material yield strength at room temperature of greater than 0.75 at 350° C., and greater than 0.80 at 180° C.;
a ratio of actual material tensile strength at a given temperature versus original material tensile strength at room temperature of greater than 0.92 at 350° C., greater than 1.06 at 180° C., and greater than 1.1 at 230° C. and 280° C.;
a ratio of material static yield strength versus material yield strength of greater than 0.83 at any strain level up to 4% and temperature up to 350° C.;
a hardening modulus greater than 7,500 MPa at 1.5% strain at any temperature up to 350° C.; and
a hardening modulus greater than 3,500 MPa at 4% strain at any temperature up to 350° C.

4. The steel tubing according to claim 1, wherein the steel consists essentially of:
about 0.28 to about 0.40 wt. % carbon;
about 1.20 to about 1.45 wt. % manganese;
a maximum of about 0.020 wt. % phosphorous;
about 0.015 to about 0.030 wt. % sulfur;
a maximum of about 0.40 wt. % silicone;
a maximum of about 0.50 wt. % chromium;
a maximum of about 0.20 wt. % molybdenum;
a maximum of about 0.010 wt. % niobium;
a maximum of about 0.020 wt. % titanium;
a maximum of about 0.020 wt. % vanadium;
a maximum of about 0.25 wt. % copper; and
a maximum of about 0.035 wt. % aluminum.

5. The steel tubing according to claim 4, having substantially the following properties:
Minimum yield strength at room temperature of 55 ksi (379.2 MPa);
Maximum yield strength at room temperature of 80 ksi (551.6 MPa);
Minimum ultimate tensile strength at room temperature of 95 ksi (655 MPa);
Minimum elongation at room temperature of 20%; and
Minimum impact toughness at room temperature of 30 J (on a longitudinal full-sized sample).

6. The steel tubing according to claim 4, having substantially the following properties:
a ratio of actual material yield strength at a given temperature versus original material yield strength at room temperature of greater than 0.75 at 350° C., and greater than 0.80 at 180° C.;
a ratio of actual material tensile strength at a given temperature versus original material tensile strength at room temperature of greater than 0.92 at 350° C., greater than 1.06 at 180° C., and greater than 1.1 at 230° C. and 280° C.;
a ratio of material static yield strength versus material yield strength of greater than 0.83 at any strain level up to 4% and temperature up to 350° C.;
a hardening modulus greater than 7,500 MPa at 1.5% strain at any temperature up to 350° C.; and
a hardening modulus greater than 3,500 MPa at 4% strain at any temperature up to 350° C.

7. The steel tubing according to claim 4, wherein the steel consists essentially of:
about 0.31 to about 0.34 wt. % carbon;
about 1.25 to about 1.40 wt. % manganese;
a maximum of about 0.020 wt. % phosphorous;
about 0.015 to about 0.025 wt. % sulfur;
a maximum of about 0.40 wt. % silicone;
a maximum of about 0.50 wt. % chromium;
a maximum of about 0.11 wt. % molybdenum;
a maximum of about 0.005 wt. % niobium;
a maximum of about 0.015 wt. % titanium;
a maximum of about 0.010 wt. % vanadium;
a maximum of about 0.25 wt. % copper; and
a maximum of about 0.025 wt. % aluminum.

8. The steel tubing according to claim 7, having substantially the following properties:
Minimum yield strength at room temperature of 55 ksi (379.2 MPa);
Maximum yield strength at room temperature of 80 ksi (551.6 MPa);
Minimum ultimate tensile strength at room temperature of 95 ksi (655 MPa);
Minimum elongation at room temperature of 20%; and
Minimum impact toughness at room temperature of 30 J (on a longitudinal full-sized sample).

9. The steel tubing according to claim 7, having substantially the following properties:
a ratio of actual material yield strength at a given temperature versus original material yield strength at room temperature of greater than 0.75 at 350° C., and greater than 0.80 at 180° C.;
a ratio of actual material tensile strength at a given temperature versus original material tensile strength at room temperature of greater than 0.92 at 350° C., greater than 1.06 at 180° C., and greater than 1.1 at 230° C. and 280° C.;
a ratio of material static yield strength versus material yield strength of greater than 0.83 at any strain level up to 4% and temperature up to 350° C.;
a hardening modulus greater than 7,500 MPa at 1.5% strain at any temperature up to 350° C.; and
a hardening modulus greater than 3,500 MPa at 4% strain at any temperature up to 350° C.

10. The steel tubing according to claim 1, wherein the steel consists essentially of:
about 0.29 wt. % carbon;
about 1.30 wt. % manganese;
about 0.013 wt. % sulfur;
about 0.012 wt. % phosphorus;
about 0.29 wt. % chromium;
about 0.15 wt. % molybdenum;
about 0.001 wt. % niobium;
about 0.002 wt. % titanium;
about 0.003 wt. % vanadium;
about 0.09 wt. % copper; and
about 0.020 wt. % aluminum.

11. The steel tubing according to claim 10, having substantially the following properties:
Minimum yield strength at room temperature of 55 ksi (379.2 MPa);
Maximum yield strength at room temperature of 80 ksi (551.6 MPa);
Minimum ultimate tensile strength at room temperature of 95 ksi (655 MPa);
Minimum elongation at room temperature of 20%; and
Minimum impact toughness at room temperature of 30 J (on a longitudinal full-sized sample).

12. The steel tubing according to claim 10, having substantially the following properties:
a ratio of actual material yield strength at a given temperature versus original material yield strength at room temperature of greater than 0.75 at 350° C., and greater than 0.80 at 180° C.;
a ratio of actual material tensile strength at a given temperature versus original material tensile strength at room temperature of greater than 0.92 at 350° C., greater than 1.06 at 180° C., and greater than 1.1 at 230° C. and 280° C.;
a ratio of material static yield strength versus material yield strength of greater than 0.83 at any strain level up to 4% and temperature up to 350° C.;
a hardening modulus greater than 7,500 MPa at 1.5% strain at any temperature up to 350° C.; and
a hardening modulus greater than 3,500 MPa at 4% strain at any temperature up to 350° C.

13. A method of treating a steel tube to enable substantial post-yield hardening behavior across a temperature range between room temperature and 350° C. while providing good slot-ability, buckling resistance and localization resistance, comprising the steps of:
Creating a billet from steel consisting essentially of:
about 0.05 to about 0.40 wt. % carbon;
about 0.50 to about 1.60 wt. % manganese;
a maximum of about 0.020 wt. % phosphorous;
about 0.005 to about 0.030 wt. % sulfur;
a maximum of about 0.40 wt. % silicone;
a maximum of about 0.50 wt. % chromium;
a maximum of about 0.50 wt. % molybdenum;
a maximum of about 0.050 wt. % niobium;
a maximum of about 0.035 wt. % titanium;
a maximum of about 0.090 wt. % vanadium;
a maximum of about 0.30 wt. % copper; and
a maximum of about 0.040 wt. % aluminum;
Hot rolling the billet into a tube and cooling the tube to room temperature;
Heating the tube to a first temperature above the corresponding AC3 temperature, and soaking the tube at approximately that first temperature for a first predetermined period of time; and
Air cooling the tube from that first temperature to room temperature over a second predetermined period of time sufficient to create a post-yield hardened steel tube characterized by a microstructure consisting essentially of either ferrite plus pearlite or a ferrite plus bainite-pearlite.

14. The method according to claim 13, wherein the first temperature is approximately 40° C. above the corresponding AC3 temperature, the first predetermined period of time is about 30 minutes, the second predetermined period of time is approximately 80 minutes and the post-yield hardened steel tube has at least one of the following properties:
Minimum yield strength at room temperature of 55 ksi (379.2 MPa);
Maximum yield strength at room temperature of 80 ksi (551.6 MPa);
Minimum ultimate tensile strength at room temperature of 95 ksi (655 MPa);
Minimum elongation at room temperature of 20%; and
Minimum impact toughness at room temperature of 30 J (on a longitudinal full-sized sample).

15. The method according to claim 13, wherein the first temperature is approximately 40° C. above the corresponding AC3 temperature, the first predetermined period of time is about 30 minutes, the second predetermined period of time is approximately 80 minutes and the post-yield hardened steel tube has at least one of the following properties:
a ratio of actual material yield strength at a given temperature versus original material yield strength at room temperature of greater than 0.75 at 350° C., and greater than 0.80 at 180° C.;
a ratio of actual material tensile strength at a given temperature versus original material tensile strength at room temperature of greater than 0.92 at 350° C., greater than 1.06 at 180° C., and greater than 1.1 at 230° C. and 280° C.;
a ratio of material static yield strength versus material yield strength of greater than 0.83 at any strain level up to 4% and temperature up to 350° C.;
a hardening modulus greater than 7,500 MPa at 1.5% strain at any temperature up to 350° C.; and
a hardening modulus greater than 3,500 MPa at 4% strain at any temperature up to 350° C.

16. The method according to claim 13, wherein the steel consists essentially of:
about 0.28 to about 0.40 wt. % carbon;
about 1.20 to about 1.45 wt. % manganese;
a maximum of about 0.020 wt. % phosphorous;
about 0.015 to about 0.030 wt. % sulfur;
a maximum of about 0.40 wt. % silicone;
a maximum of about 0.50 wt. % chromium;
a maximum of about 0.20 wt. % molybdenum;
a maximum of about 0.010 wt. % niobium;
a maximum of about 0.020 wt. % titanium;
a maximum of about 0.020 wt. % vanadium;
a maximum of about 0.25 wt. % copper; and
a maximum of about 0.035 wt. % aluminum.

17. The method according to claim 16, wherein the first temperature is approximately 40° C. above the corresponding AC3 temperature, the first predetermined period of time is about 30 minutes, the second predetermined period of time is approximately 80 minutes and the post-yield hardened steel tube has substantially the following properties:
Minimum yield strength at room temperature of 55 ksi (379.2 MPa);
Maximum yield strength at room temperature of 80 ksi (551.6 MPa);
Minimum ultimate tensile strength at room temperature of 95 ksi (655 MPa);
Minimum elongation at room temperature of 20%; and
Minimum impact toughness at room temperature of 30 J (on a longitudinal full-sized sample).

18. The method according to claim 16, wherein the first temperature is approximately 40° C. above the corresponding AC3 temperature, the first predetermined period of time is about 30 minutes, the second predetermined period of time is approximately 80 minutes and the post-yield hardened steel tube has substantially the following properties:
a ratio of actual material yield strength at a given temperature versus original material yield strength at room temperature of greater than 0.75 at 350° C., and greater than 0.80 at 180° C.;
a ratio of actual material tensile strength at a given temperature versus original material tensile strength at room temperature of greater than 0.92 at 350° C., greater than 1.06 at 180° C., and greater than 1.1 at 230° C. and 280° C.;
a ratio of material static yield strength versus material yield strength of greater than 0.83 at any strain level up to 4% and temperature up to 350° C.;
a hardening modulus greater than 7,500 MPa at 1.5% strain at any temperature up to 350° C.; and
a hardening modulus greater than 3,500 MPa at 4% strain at any temperature up to 350° C.

19. The method according to claim 13, wherein the steel consists essentially of:
about 0.29 wt. % carbon;
about 1.30 wt. % manganese;
about 0.013 wt. % sulfur;
about 0.012 wt. % phosphorus;
about 0.29 wt. % chromium;
about 0.15 wt. % molybdenum;
about 0.001 wt. % niobium;
about 0.002 wt. % titanium;
about 0.003 wt. % vanadium;
about 0.09 wt. % copper; and
about 0.020 wt. % aluminum.

20. The method according to claim 19, wherein the first temperature is approximately 40° C. above the corresponding AC3 temperature, the first predetermined period of time is about 30 minutes, the second predetermined period of time is approximately 80 minutes and the post-yield hardened steel tube has substantially the following properties:
Minimum yield strength at room temperature of 55 ksi (379.2 MPa);
Maximum yield strength at room temperature of 80 ksi (551.6 MPa);
Minimum ultimate tensile strength at room temperature of 95 ksi (655 MPa);
Minimum elongation at room temperature of 20%; and
Minimum impact toughness at room temperature of 30 J (on a longitudinal full-sized sample).

21. The method according to claim 19, wherein the first temperature is approximately 40° C. above the corresponding AC3 temperature, the first predetermined period of time is about 30 minutes, the second predetermined period of time is approximately 80 minutes and the post-yield hardened steel tube has substantially the following properties:
a ratio of actual material yield strength at a given temperature versus original material yield strength at room temperature of greater than 0.75 at 350° C., and greater than 0.80 at 180° C.;
a ratio of actual material tensile strength at a given temperature versus original material tensile strength at room temperature of greater than 0.92 at 350° C., greater than 1.06 at 180° C., and greater than 1.1 at 230° C. and 280° C.;
a ratio of material static yield strength versus material yield strength of greater than 0.83 at any strain level up to 4% and temperature up to 350° C.;
a hardening modulus greater than 7,500 MPa at 1.5% strain at any temperature up to 350° C.; and
a hardening modulus greater than 3,500 MPa at 4% strain at any temperature up to 350° C.

22. A post-yield hardened steel tube produced by the method of claim 14.

23. A post-yield hardened steel tube produced by the method of claim 17.

24. A post-yield hardened steel tube produced by the method of claim 20.

25. A method of producing steel tubing with enhanced slot-ability, buckling resistance and localization resistance, comprising the steps of:
producing a solid bar from a steel consisting essentially of:
about 0.05 to about 0.40 wt. % carbon;
about 0.50 to about 1.60 wt. % manganese;
a maximum of about 0.020 wt. % phosphorous;
about 0.005 to about 0.030 wt. % sulfur;
a maximum of about 0.40 wt. % silicone;
a maximum of about 0.50 wt. % chromium;
a maximum of about 0.50 wt. % molybdenum;
a maximum of about 0.050 wt. % niobium;
a maximum of about 0.035 wt. % titanium;
a maximum of about 0.090 wt. % vanadium;
a maximum of about 0.30 wt. % copper; and
a maximum of about 0.040 wt. % aluminum;
cutting the bar into billets;
hot rolling the billets into tubing;
cooling the tubing to room temperature;
heating the tubing to approximately 40° C. above the corresponding AC3 temperature;
soaking the tubing at approximately 40° C. above the corresponding AC3 temperature for about 10 minutes; and
cooling the tubing to room temperature to create resulting steel tubing which is post-yield hardened and exhibits a microstructure consisting essentially of either ferrite plus pearlite or a ferrite plus bainite-pearlite.

26. The method according to claim 25, wherein the step of cooling to room temperature to create the resulting tubing is by air over approximately 80 minutes and the resulting steel tubing has substantially the following properties:
Minimum yield strength at room temperature of 55 ksi (379.2 MPa);
Maximum yield strength at room temperature of 80 ksi (551.6 MPa);
Minimum ultimate tensile strength at room temperature of 95 ksi (655 MPa);
Minimum elongation at room temperature of 20%; and
Minimum impact toughness at room temperature of 30 J (on a longitudinal full-sized sample).

27. The method according to claim 25, wherein the resulting steel tubing has substantially the following properties:
a ratio of actual material yield strength at a given temperature versus original material yield strength at room temperature of greater than 0.75 at 350° C., and greater than 0.80 at 180° C.;
a ratio of actual material tensile strength at a given temperature versus original material tensile strength at room temperature of greater than 0.92 at 350° C., greater than 1.06 at 180° C., and greater than 1.1 at 230° C. and 280° C.;
a ratio of material static yield strength versus material yield strength of greater than 0.83 at any strain level up to 4% and temperature up to 350° C.;
a hardening modulus greater than 7,500 MPa at 1.5% strain at any temperature up to 350° C.; and
a hardening modulus greater than 3,500 MPa at 4% strain at any temperature up to 350° C.

28. The method according to claim 25, wherein said steel consists essentially of:
about 0.28 to about 0.40 wt. % carbon;
about 1.20 to about 1.45 wt. % manganese;
a maximum of about 0.020 wt. % phosphorous;
about 0.015 to about 0.030 wt. % sulfur;
a maximum of about 0.40 wt. % silicone;
a maximum of about 0.50 wt. % chromium;
a maximum of about 0.20 wt. % molybdenum;
a maximum of about 0.010 wt. % niobium;
a maximum of about 0.020 wt. % titanium;
a maximum of about 0.020 wt. % vanadium;
a maximum of about 0.25 wt. % copper; and
a maximum of about 0.035 wt. % aluminum.

29. The method according to claim 28, wherein the step of cooling to room temperature to create the resulting tubing is by air over approximately 80 minutes and the resulting steel tubing has substantially the following properties:
Minimum yield strength at room temperature of 55 ksi (379.2 MPa);
Maximum yield strength at room temperature of 80 ksi (551.6 MPa);
Minimum ultimate tensile strength at room temperature of 95 ksi (655 MPa);
Minimum elongation at room temperature of 20%; and
Minimum impact toughness at room temperature of 30 J (on a longitudinal full-sized sample).

30. The method according to claim 28, wherein the resulting steel tubing has substantially the following properties:
a ratio of actual material yield strength at a given temperature versus original material yield strength at room temperature of greater than 0.75 at 350° C., and greater than 0.80 at 180° C.;
a ratio of actual material tensile strength at a given temperature versus original material tensile strength at room temperature of greater than 0.92 at 350° C., greater than 1.06 at 180° C., and greater than 1.1 at 230° C. and 280° C.;
a ratio of material static yield strength versus material yield strength of greater than 0.83 at any strain level up to 4% and temperature up to 350° C.;
a hardening modulus greater than 7,500 MPa at 1.5% strain at any temperature up to 350° C.; and
a hardening modulus greater than 3,500 MPa at 4% strain at any temperature up to 350° C.

31. The method according to claim 28, wherein said steel comprises:
about 0.29 wt. % carbon;
about 1.30 wt. % manganese;
about 0.013 wt. % sulfur;
about 0.012 wt. % phosphorus;
about 0.29 wt. % chromium;
about 0.15 wt. % molybdenum;
about 0.001 wt. % niobium;
about 0.002 wt. % titanium;
about 0.003 wt. % vanadium;
about 0.09 wt. % copper; and
about 0.020 wt. % aluminum.

32. The method according to claim 31, wherein the step of cooling to room temperature to create the resulting tubing is by air over approximately 80 minutes and the resulting steel tubing has substantially the following properties:
Minimum yield strength at room temperature of 55 ksi (379.2 MPa);
Maximum yield strength at room temperature of 80 ksi (551.6 MPa);
Minimum ultimate tensile strength at room temperature of 95 ksi (655 MPa);
Minimum elongation at room temperature of 20%; and
Minimum impact toughness at room temperature of 30 J (on a longitudinal full-sized sample).

33. The method according to claim 31, wherein the resulting steel tubing and substantially comprises the following properties:
a ratio of actual material yield strength at a given temperature versus original material yield strength at room temperature of greater than 0.75 at 350° C., and greater than 0.80 at 180° C.;
a ratio of actual material tensile strength at a given temperature versus original material tensile strength at room temperature of greater than 0.92 at 350° C., greater than 1.06 at 180° C., and greater than 1.1 at 230° C. and 280° C.;
a ratio of material static yield strength versus material yield strength of greater than 0.83 at any strain level up to 4% and temperature up to 350° C.;
a hardening modulus greater than 7,500 MPa at 1.5% strain at any temperature up to 350° C.; and
a hardening modulus greater than 3,500 MPa at 4% strain at any temperature up to 350° C.

34. A post-yield hardened steel tubing produced by the method of claim 26.

35. A post-yield hardened steel tubing produced by the method of claim 29.

36. A post-yield hardened steel tubing produced by the method of claim 32.
